(19) United States
(12) Patent Application Publication
(10) Pub. No.: US 2021/0125159 A1
(43) Pub. Date: Apr. 29, 2021

(54) DIRECT FUND TRANSFER FROM AID ORGANIZATIONS TO SERVICE PROVIDERS

(71) Applicant: MASTERCARD INTERNATIONAL INCORPORATED, Purchase, NY (US)

(72) Inventors: Paul Michael Musser, Grass Valley, CA (US); Penelope Psarros, Dubai (AE); Ali Khalaf, Manama (BH); Yara Hattab, Dubai (AE); Chirag Sharma, Dubai (AE); Mohammad Al-Hussein, Dubai (AE)

(73) Assignee: MASTERCARD INTERNATIONAL INCORPORATED, Purchase, NY (US)

(21) Appl. No.: 16/661,721

(22) Filed: Oct. 23, 2019

(51) Int. Cl. G06Q 20/10; G06Q 40/02; G06Q 20/20; G06Q 20/40

(52) U.S. Cl. CPC G06Q 20/10; G06Q 20/405; G06Q 20/20; G06Q 40/02

(57) ABSTRACT

Systems, devices and methods may provide for facilitating a direct fund transfer from an aid organization to a service provider. The system may maintain an aid organization account associated with the aid organization, maintain a beneficiary account associated with each beneficiary enrolled with the aid organization, and maintain a service provider account associated with each service provider. Each beneficiary account may be configured as a virtual stored-value account for storing value corresponding to funds from the aid organization. The system may also receive transaction data corresponding to a transaction between a beneficiary and a service provider including identifier information, debit a value corresponding to the transaction amount from the beneficiary account that is mapped to a beneficiary identifier, and transfer funds corresponding to the transaction amount from the aid organization account directly to a service provider account that is mapped to a service provider identifier.

### FIELD OF INVENTION

The present disclosure relates broadly, but not exclusively, to systems, devices and methods for facilitating a direct fund transfer from aid organizations to service providers.

### BACKGROUND

A donation is a gift from a donor (which can be an individual person or legal entity) to a beneficiary (which is usually an individual person), typically for charitable purposes and/or to benefit a cause. A donation may take various forms, including cash, services and goods. In most cases, a non-governmental charitable organization (hereinafter referred to as an aid organization) administers the collection of donations from donors and distributes the donations to the beneficiaries enrolled with the aid organization.

Currently, the majority of donations are distributed as value-in-kind, i.e., non-cash products such as food and clothes. A smaller portion of donations are cash-based. Moreover, the majority of the cash-based donations are unrestricted in the sense that beneficiaries have the sole discretion on how they wish to spend the cash-based donations. In other words, they are not restricted to spend at prescribed merchants or on a certain category of products (e.g., only on groceries, healthcare, etc.).

However, currently most aid organizations struggle to efficiently reconcile and track such unrestricted cash-based donations. For example, it is time-consuming to transfer funds from the aid organization headquarters to its respective local offices. Moreover, the respective local offices typically are solely responsible for the administration of the received funds and has to convince individual service providers (e.g., merchants, providers of goods and services) to participate in aid programs run by the local offices. If a service provider decides to participate in an aid program run by the local office, the local office usually has to closely supervise the implementation of the aid program by the service provider. This usually requires significant effort, time and resources from the local office.

In some cases, to encourage service providers to participate in aid programs run by the local offices, service providers are pre-paid by the local office to provide prescribed goods or services to the beneficiaries. However, this can result in the local office paying for certain goods or services that are not eventually used by the beneficiaries.

The local offices are also required to report their individual financial and operational performance to the aid organization headquarters. Significant effort, time and resources are required from the local offices to accurately track and analyze the distribution of unrestricted cash-based donations to beneficiaries and payment to service providers.

A need therefore exists to provide devices and methods that seek to overcome or at least minimize the above mentioned problems.

### SUMMARY

According to a first aspect, there is provided a processing device for facilitating a direct fund transfer from an aid organization to a service provider, including: (i) an account management module configured to: maintain an aid organization account associated with the aid organization; maintain a beneficiary account associated with each beneficiary that is enrolled with the aid organization, wherein each beneficiary account is configured as a virtual stored-value account for storing value corresponding to funds from the aid organization; and maintain a service provider account associated with each service provider; and (ii) a transaction settlement module configured to: receive transaction data corresponding to a transaction between a beneficiary and a service provider, wherein the transaction data comprises a beneficiary identifier, a service provider identifier and a transaction amount. The account management module is further configured to: debit a value corresponding to the transaction amount from the beneficiary account that is mapped to the beneficiary identifier, and the transaction settlement module is further configured to: transfer funds corresponding to the transaction amount from the aid organization account directly to the service provider account that is mapped to the service provider identifier.

According to a second aspect, there is provided a method for facilitating a direct fund transfer from an aid organization to a service provider, including: maintaining, by an account management module, an aid organization account associated with the aid organization; maintaining, by the account management module, a beneficiary account associated with each beneficiary that is enrolled with the aid organization; configuring, by the account management module, each beneficiary account as a virtual stored-value account for storing value corresponding to funds from the aid organization; maintaining, by the account management module, a service provider account associated with each service provider; receiving, at a transaction settlement module that is in communication with the account management module, transaction data corresponding to a transaction between a beneficiary and a service provider, wherein the transaction data comprises a beneficiary identifier, a service provider identifier and a transaction amount; debiting, by the account management module, a value corresponding to the transaction amount from the beneficiary account that is mapped to the beneficiary identifier; and transferring, by the transaction settlement module, funds corresponding to the transaction amount from the aid organization account directly to the service provider account that is mapped to the service provider identifier.

### BRIEF DESCRIPTION OF THE DRAWINGS

Embodiments and implementations are provided by way of example only, and will be better understood and readily apparent to one of ordinary skill in the art from the following written description, read in conjunction with the drawings, in which:

FIG. 1 shows a schematic diagram of a processing device for facilitating a direct fund transfer from an aid organization to a service provider, according to an example embodiment.

FIG. 2 shows a flow chart illustrating a method for facilitating a direct fund transfer from an aid organization to a service provider, according to an example embodiment.

FIG. 3 shows a process and data flow diagram illustrating a method for facilitating a direct fund transfer from an aid organization to a service provider, according to an example embodiment.

FIG. 4 shows a schematic diagram of a computer system suitable for use in executing at least some steps of the method for facilitating a direct fund transfer from an aid organization to a service provider and/or for realizing at least a part of the processing device, service provider device and/or aid organization device.

### DETAILED DESCRIPTION

Embodiments will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “receiving”, “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer suitable for executing the various methods/processes described herein will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the disclosure. The steps of the method may also be implemented in one or more modules as a set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TTL) technology, or any combination thereof

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a computer effectively results in an apparatus that implements the steps of the preferred method.

Embodiments seek to provide a business-to-business (B2B) digital solution enabling aid organizations to directly transfer funds and track usage using a closed-loop network of service providers. In particular, embodiments seek to provide devices and methods for facilitating a direct fund transfer from aid organizations to service providers, without involving beneficiaries.

In the current context, a beneficiary is an individual person (or, in some cases, an entity) that receives cash donations from donors. An aid organization is an entity that administers the collection of cash donations from donors and distributes the donations to the beneficiaries enrolled with the aid organization. Service providers are merchants or providers of goods and services.

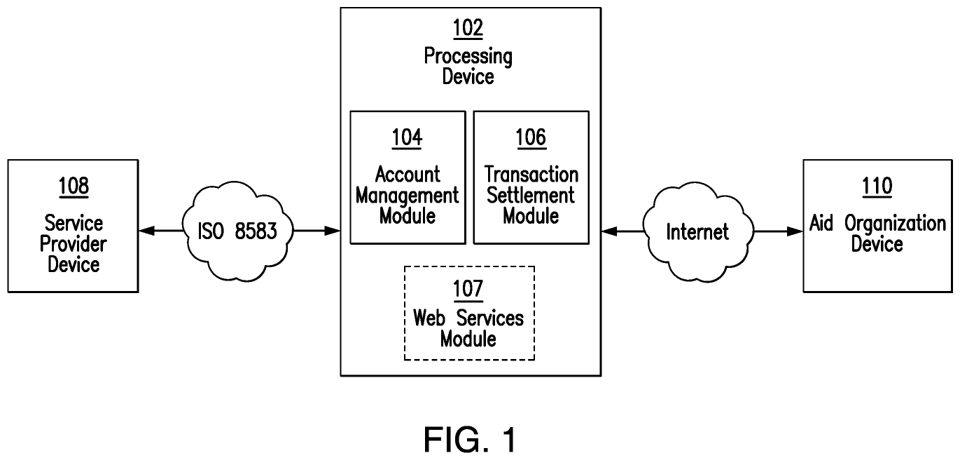

FIG. 1 shows a schematic diagram of a processing device 102 for facilitating a direct fund transfer from an aid organization to a service provider, according to an example embodiment. The processing device 102 includes an account management module 104 and a transaction settlement module 106. In the following description, the term “module” (e.g., account management module, transaction settlement module, etc.) can refer to software, a hardware element, or a combination of both. The account management module 104 is configured to maintain an aid organization account that is associated with the aid organization. The account management module 104 is also configured to maintain a beneficiary account associated with each beneficiary that is enrolled with the aid organization. Each beneficiary account is configured as a virtual stored-value account for storing value corresponding to funds received from the aid organization. The virtual stored-value account is an account in which the aid organization credits allocated funds for the beneficiary to use. Funds are debited from the stored-value account whenever the beneficiary makes a purchase transaction. If there are insufficient funds, the purchase transaction is not authorized. Unlike a typical debit card, the stored-value account need not be linked to a beneficiary's bank account. This is advantageous for “unbanked” beneficiaries. The account management module 104 is also configured to maintain a service provider account associated with each service provider.

It will be readily appreciated that the processing device 102 can have multiple account management modules and/or transaction settlement modules, depending on the requirements of each implementation. However, for the sake of brevity, in the foregoing description the processing device 102 has one account management module and one transaction settlement module. Moreover, an account management module can maintain more than one beneficiary account, service provider account and/or aid organization account, depending on the requirements of each implementation.

The transaction settlement module 106 is configured to receive transaction data corresponding to a transaction between a beneficiary and a service provider. The transaction data can include, but is not limited to, a beneficiary identifier, a service provider identifier and a transaction amount. The beneficiary identifier is unique to the beneficiary; likewise, the service provider identifier is unique to the service provider. These two identifiers (e.g., comprising string of alphanumeric characters) are used to identify the parties to the transaction. The account management module 104 is further configured to debit a value corresponding to the transaction amount from the beneficiary account that is mapped to the beneficiary identifier. The transaction settlement module 106 is further configured to transfer funds corresponding to the transaction amount from the aid organization account directly to the service provider account that is mapped to the service provider identifier. In this manner, a business-to-business (B2B) digital solution is provided that enables aid organizations to directly transfer funds to service providers and track usage using a closed-loop network of service providers. The beneficiary is not directly involved in the fund transfer process. Accordingly, embodiments can support “unbanked” beneficiaries (i.e., those not having access to the services of a bank or similar financial organization).

The transaction settlement frequency can be pre-determined. In other words, the transaction settlement module 106 can be further configured to transfer the funds corresponding to the transaction amount from the aid organization account directly to the service provider account that is mapped to the service provider identifier at a pre-determined frequency level. The pre-determined frequency level can be determined by the aid organization and the service provider. This is in contrast to current settlement practices where settlement frequency is fixed by financial institutions and generally cannot be changed. The account management module 104 can be configured to allocate a virtual account for each service provider (e.g., grocery shop, pharmacy, etc.). Once a purchase transaction occurs, the transaction settlement module 106 can be configured to manage the settlement between the aid organization account and the service provider account.

The processing device 102 can be in communication with a service provider device 108 using a message format and a communication flow in accordance with ISO 8583. The service provider device 108 is expected to be located at the service provider's premises and may be in the form of a point-of-sale (POS) terminal or computing device. The service provider device 108 can be specially configured to generate the transaction data corresponding to the transaction between the beneficiary and the service provider. For example, a beneficiary wants to purchase a product from the service provider's store. The beneficiary goes to the check-out counter and provides his/her beneficiary identifier. Preferably, the beneficiary authenticates himself/herself, e.g., by entering a personal identification number (PIN) at the service provider device 108 or via biometric authentication, before being allowed to proceed with the purchase. The PIN is set by the beneficiary during the enrolment process and stored, e.g. in the account management module 104. The service provider inputs the price of the product at the service provider device 108. The beneficiary identifier and the price of the product (i.e., transaction amount) can be sent from the service provider device 108 to the processing device 102.

The account management module 104 can be further configured to receive, from an aid organization device 110, the beneficiary identifier and a value to be stored in the beneficiary's virtual stored-value account. The processing device 102 can be in communication with the aid organization device 110 via an Internet connection. The aid organization device 110 can be a mobile computing device that is connected to the processing device 102. The processing device 102 has a web services module 107 that can host a web portal. In this manner, the aid organization device 110 can access the web portal; the beneficiary identifier and value to be stored in the virtual stored-value account can be input using the web portal.

The account management module 104 can be further configured to create the beneficiary account and also map the beneficiary account to the beneficiary identifier. The mapping can be stored in a database (not shown in FIG. 1) of the processing device 102. Further, the account management module 104 can be configured to update the beneficiary account based on the value to be stored in the virtual stored-value account.

In an exemplary implementation, the account management module 104 can be configured to receive, from the aid organization device 110, the service provider identifier. The account management module 104 can create the service provider account and also map the service provider account to the service provider identifier. The mapping can be stored in a database (not shown in FIG. 1) of the processing device 102.

In an exemplary transaction settlement process, the account management module 104 can be further configured to update the service provider account that is mapped to the service provider identifier by crediting the value corresponding to the transaction amount, and update the aid organization account by debiting the value corresponding to the transaction amount.

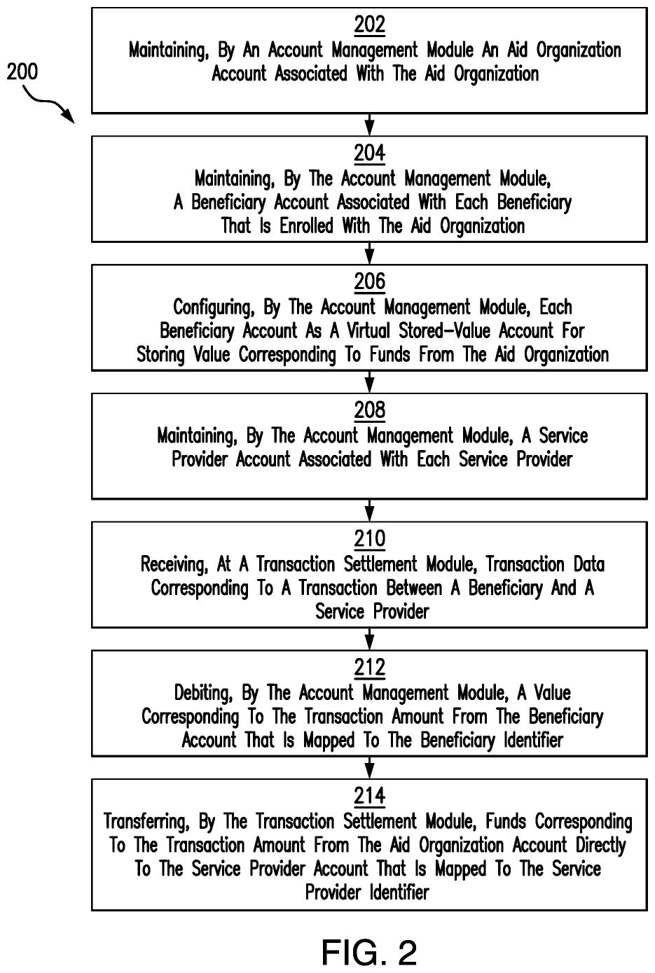

FIG. 2 shows a flow chart 200 illustrating a method for facilitating a direct fund transfer from an aid organization to a service provider, according to an example embodiment. Each of the steps of the method may be performed sequentially; or when applicable, in parallel or in any order (e.g., step 204 before 202). The method includes step 202 which involves maintaining, by an account management module (e.g., account management module 104 described above), an aid organization account that is associated with the aid organization. The method further includes step 204 which involves maintaining, by the account management module, a beneficiary account associated with each beneficiary that is enrolled with the aid organization. Step 206 involves configuring, by the account management module, each beneficiary account as a virtual stored-value account for storing value corresponding to funds from the aid organization. Step 208 involves maintaining, by the account management module, a service provider account associated with each service provider. Steps 202, 204 and 208 can be performed in any order or in parallel. Step 210 involves receiving, at a transaction settlement module (e.g., transaction settlement module 106 described above) that is in communication with the account management module, transaction data corresponding to a transaction between a beneficiary and a service provider. The transaction data includes, but is not limited to: a beneficiary identifier, a service provider identifier and a transaction amount. Step 212 involves debiting, by the account management module, a value corresponding to the transaction amount from the beneficiary account that is mapped to the beneficiary identifier. Step 214 involves transferring, by the transaction settlement module, funds corresponding to the transaction amount from the aid organization account directly to the service provider account that is mapped to the service provider identifier. The step 214 of transferring the funds corresponding to the transaction amount from the aid organization account directly to the service provider account that is mapped to the service provider identifier can be performed at a pre-determined frequency level. The pre-determined frequency level can be determined by the aid organization and the service provider.

When the beneficiary wishes to purchase a good or service from the service provider, the method may further comprise the step of generating, at a service provider device (e.g., service provider device 108 described above), the transaction data corresponding to the transaction between the beneficiary and the service provider. The service provider device is in communication with the transaction settlement module using a message format and a communication flow in accordance with ISO 8583. The service provider device 108 is expected to be located at the service provider's premises and can be in the form of a point-of-sale (POS) terminal that is specifically configured to generate the transaction data corresponding to the transaction between the beneficiary and the service provider.

In order for the aid organization to “top-up” the beneficiary's virtual stored-value account with funds, the method may further comprise the step of receiving, at the account management module from an aid organization device (e.g., aid organization device 110 described above), the beneficiary identifier and a value to be stored in the virtual stored-value account. This step can be performed whenever the beneficiary's virtual stored-value account needs to be “topped-up”. The aid organization device can be a mobile computing device that is connected to the processing device 102 as described above. The processing device 102 has a web services module 107 that can host a web portal. In this manner, the aid organization device can access the web portal; the beneficiary identifier and value to be stored in the virtual stored-value account can be input using the web portal.

Prior to step 204, the method may further comprise the step of creating, by the account management module, the beneficiary account. After the beneficiary account is created, the account management module can map the beneficiary account to the beneficiary identifier. Mapping the beneficiary account to the beneficiary identifier allows a particular beneficiary account to be linked to, and identified by, a unique beneficiary identifier. The beneficiary identifier can be generated by the aid organization device or manually assigned by an administrator of the aid organization. Once the beneficiary identifier is mapped to the beneficiary account, the account management module can update the beneficiary account based on the value to be stored in the particular beneficiary's virtual stored-value account.

The method may further comprise the step of receiving, at the account management module from the aid organization device, the service provider identifier. Prior to step 208, the method may further comprise the step of creating, by the account management module, the service provider account. Thereafter, the account management module can map the service provider account to the service provider identifier. Mapping the service provider account to the service provider identifier allows a particular the service provider account to be linked to, and identified by, a unique the service provider identifier.

The method may further comprise the step of updating, by the account management module, the service provider account that is mapped to the service provider identifier by crediting the value corresponding to the transaction amount. The method may further comprise the step of updating, by the account management module, the aid organization account by debiting the value corresponding to the transaction amount.

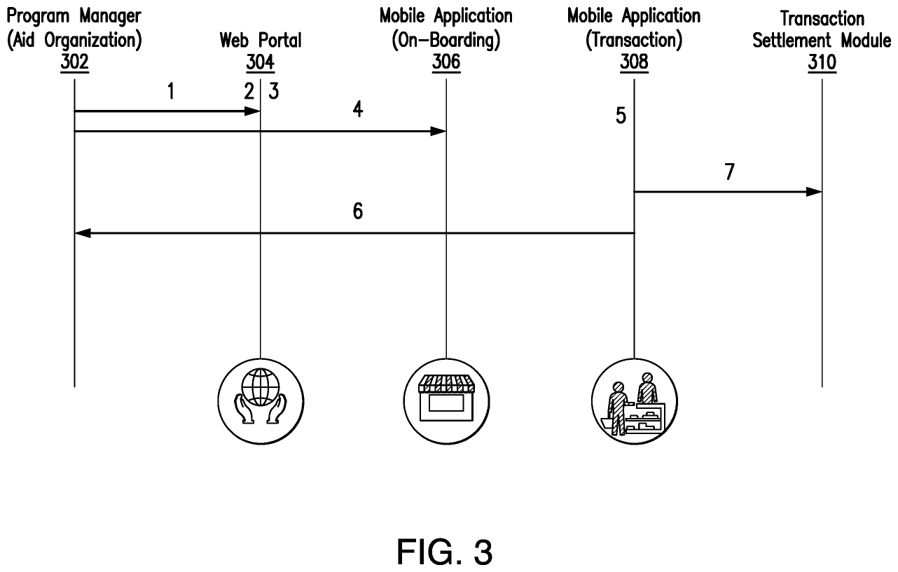

FIG. 3 shows a process and data flow diagram illustrating a method for facilitating a direct fund transfer from an aid organization to a service provider, according to an example embodiment. At step 1, a staff member of the aid organization (hereinafter referred to as a program manager 302) who administers an aid program that is run by the aid organization logs onto a Web Portal 304. The web services module 107 described above can be configured to host the Web Portal 304. The Web Portal 304 allows the program manager 302 to create an aid program (e.g., a program that seeks to help expectant mothers in sub-Saharan Africa). The program manager 302 can also use the Web Portal 304 to create and update a beneficiary database associated with the aid program. The beneficiary database can include details of each beneficiary (e.g., name, address, demographic profile, ethnicity, particular needs, etc.) and a unique beneficiary identifier of each beneficiary.

At step 2, the program manager 302 uses the Web Portal 304 to create a virtual stored-value account for each beneficiary. Each virtual stored-value account is linked/mapped to the unique beneficiary identifier of a respective beneficiary. The account management module 104 described above can be configured to create and maintain these virtual stored-value accounts. Steps 1 and 2 may be collective referred to as a “beneficiary on-boarding process”.

At step 3, after the aid organization collects cash donations from donors, the program manager 302 allocates these funds to each beneficiary by updating each beneficiary's virtual stored-value account. In other words, the virtual stored-value accounts are used to store value corresponding to allocated funds from the aid organization. The account management module 104 described above can be configured to create and maintain an aid organization account associated with the aid organization. The aid organization account can hold all the collected cash donations from donors. One aid organization may have multiple aid organization accounts, e.g., each program that is run by the aid organization is designated one independent account. In this manner, all cash donations from donors for a particular program are transferred to the designated independent account.

At step 4, the program manager 302 visits each service provider (e.g., merchants, providers of goods and services, hospitals) and uses a “program manager-side” mobile application 306 for on-boarding of service providers. The web services module 107 described above can be configured to host the “program manager-side” mobile application 306. The “program manager-side” mobile application 306 can be assessed using a mobile computing device. During this “service provider on-boarding” process, the program manager collects the relevant information from each service provider (e.g., name, address, category of goods and services provided, company registration number, etc.) and uploads to a database using the mobile application 306. The account management module 104 described above can be configured to create and maintain a service provider account associated with each on-boarded service provider. The main function of the service provider account is to receive funds (i.e., monetary compensation) for goods/services provided to beneficiaries. As will be explained in more detail below, the funds are received directly from the aid organization and not from the beneficiaries.

At step 5, the beneficiary wishes to purchase a good/service from a desired service provider. The beneficiary approaches the service provider to pay for the good/service. The service provider asks the beneficiary for his unique beneficiary identifier. The service provider uses a “service provider-side” mobile application 308 to conduct this transaction. The “service provider-side” mobile application 308 can be accessed using a point-of-sale (POS) terminal or a computing device at the service provider's premises. The web services module 107 described above can be configured to host the “service provider-side” mobile application 308. To initiate the transaction, the service provider inputs the beneficiary identifier and transaction amount (i.e., total cost of goods/services purchased by the beneficiary). Optionally, the beneficiary authenticates himself/herself, e.g., by entering a personal identification number (PIN) on the “service provider-side” mobile application 308 before being allowed to proceed with the purchase. The “service provider-side” mobile application 308 can display the transaction amount (i.e., the amount of funds deducted from the beneficiary account) and the amount of funds remaining in the beneficiary account. In this manner, the beneficiary does not need to have his/her own mobile computing device, smartphone, mobile phone, credit card, debit card, etc. to purchase goods/services. This is especially critical as many of these beneficiaries have lower incomes and are unbanked and/or cannot afford mobile computing devices/smartphones/mobile phones.

At step 6, the transaction is recorded and the program manager is notified accordingly 302.

At step 7, a transaction settlement module 310 (similar to transaction settlement module 106 described above) receives the transaction data from the “service provider-side” mobile application 308. The received transaction data comprises a beneficiary identifier, a service provider identifier and a transaction amount. Settlement of the transaction occurs on the beneficiary's virtual stored-value account at a frequency level agreed between the aid organization and the service provider. The settlement of the transaction involves: (i) debiting a value corresponding to the transaction amount from the beneficiary account that is mapped to the beneficiary identifier, and (ii) transferring funds corresponding to the transaction amount from the aid organization account directly to the service provider account that is mapped to the service provider identifier. In other words, the funds are received by the service provider directly from the aid organization and not from the beneficiary. The sub-step (ii) of transferring funds corresponding to the transaction amount from the aid organization account directly to the service provider account that is mapped to the service provider identifier may involve: (a) updating the service provider account that is mapped to the service provider identifier by crediting the value corresponding to the transaction amount; and (b) updating the aid organization account by debiting the value corresponding to the transaction amount.

As mentioned above, currently most aid organizations struggle to efficiently reconcile and track unrestricted cash-based donations. For example, it is time-consuming to transfer funds from the aid organization headquarters to its respective local offices. Moreover, the respective local offices typically are solely responsible for the administration of the received funds and has to convince individual service providers (e.g., merchants, providers of goods and services, and the like) to participate in aid programs run by the local offices. If a service provider decides to participate in an aid program run by the local office, the local office usually has to closely supervise the implementation of the aid program by the service provider. This usually requires significant effort, time and resources from the local office. Advantageously, embodiments described above can provide fast and secure fund transfers directly from the aid organization to the service provider. It is no longer necessary for a local office to have staff with payment/accounting expertise.

In some cases, to encourage service providers to participate in aid programs run by the local offices, service providers are pre-paid by the local office to provide prescribed goods or services to the beneficiaries. However, this can result in the local office paying for certain goods or services that are not eventually used by the beneficiaries. Advantageously, embodiments described above allow the service provider to only pay for goods and services actually purchased by beneficiaries.

The local offices are also required to report their individual financial and operational performance to the aid organization headquarters. Significant effort, time and resources are required from the local offices to accurately track and analyze the distribution of unrestricted cash-based donations to beneficiaries and payment to service providers. Advantageously, embodiments described above can provide a centralized analytics and accounting portal. For example, all the transactions between the beneficiaries and the various service providers can be aggregated and displayed on the Web Portal 304. The Web Portal 304 can provide the centralized analytics and accounting portal (e.g., how much the beneficiaries are spending within a certain time frame, which category of goods/services are more popular, etc.)

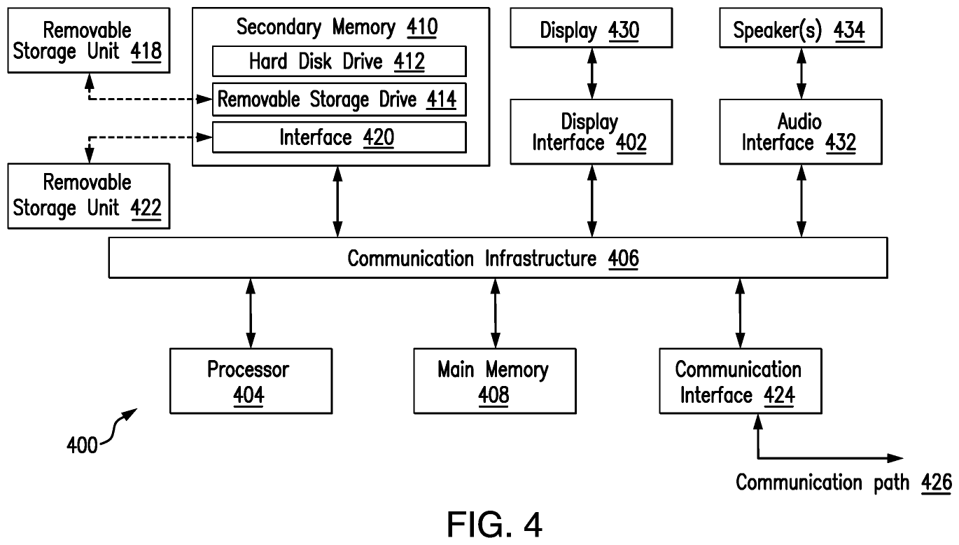

FIG. 4 shows a schematic diagram of a computer system suitable for use in executing at least some steps of the method for facilitating a direct fund transfer from an aid organization to a service provider and/or for realizing at least a part of the processing device 102, service provider device 108 and/or aid organization device 110.

The following description of the computer system/computing device 400 is provided by way of example only and is not intended to be limiting.

As shown in FIG. 4, the example computing device 400 includes a processor 404 for executing software routines. Although a single processor is shown for the sake of clarity, the computing device 400 may also include a multi-processor system. The processor 404 is connected to a communication infrastructure 406 for communication with other components of the computing device 400. The communication infrastructure 406 may include, for example, a communications bus, cross-bar, or network. The computing device 400 further includes a main memory 408, such as a random access memory (RAM), and a secondary memory 410. The secondary memory 410 may include, for example, a hard disk drive 412 and/or a removable storage drive 414, which may include a magnetic tape drive, an optical disk drive, or the like. The removable storage drive 414 reads from and/or writes to a removable storage unit 418 in a well-known manner. The removable storage unit 418 may include a magnetic tape, optical disk, or the like, which is read by and written to by removable storage drive 414. As will be appreciated by persons skilled in the relevant art(s), the removable storage unit 418 includes a computer readable storage medium having stored therein computer executable program code instructions and/or data.

In an alternative implementation, the secondary memory 410 may additionally or alternatively include other similar means for allowing computer programs or other instructions to be loaded into the computing device 400. Such means can include, for example, a removable storage unit 422 and an interface 420. Examples of a removable storage unit 422 and interface 420 include a removable memory chip (such as an EPROM or PROM) and associated socket, and other removable storage units 422 and interfaces 420 which allow software and data to be transferred from the removable storage unit 422 to the computer system 400.

The computing device 400 also includes at least one communication interface 424. The communication interface 424 allows software and data to be transferred between computing device 400 and external devices via a communication path 426. In various embodiments, the communication interface 424 permits data to be transferred between the computing device 400 and a data communication network, such as a public data or private data communication network. The communication interface 424 may be used to exchange data between different computing devices 400 which such computing devices 400 form part an interconnected computer network. Examples of a communication interface 424 can include a modem, a network interface (such as an Ethernet card), a communication port, an antenna with associated circuitry and the like. The communication interface 424 may be wired or may be wireless. Software and data transferred via the communication interface 424 are in the form of signals which can be electronic, electromagnetic, optical or other signals capable of being received by communication interface 424. These signals are provided to the communication interface via the communication path 426.

Optionally, the computing device 400 further includes a display interface 402 which performs operations for rendering images to an associated display 430 and an audio interface 432 for performing operations for playing audio content via associated speaker(s) 434.

As used herein, the term “computer program product” may refer, in part, to removable storage unit 418, removable storage unit 422, a hard disk installed in hard disk drive 412, or a carrier wave carrying software over communication path 426 (wireless link or cable) to communication interface 424. Computer readable storage media refers to any non-transitory tangible storage medium that provides recorded instructions and/or data to the computing device 400 for execution and/or processing. Examples of such storage media include floppy disks, magnetic tape, CD-ROM, DVD, Blu-ray™ Disc, a hard disk drive, a ROM or integrated circuit, USB memory, a magneto-optical disk, or a computer readable card such as a PCMCIA card and the like, whether or not such devices are internal or external of the computing device 400. Examples of transitory or non-tangible computer readable transmission media that may also participate in the provision of software, application programs, instructions and/or data to the computing device 400 include radio or infra-red transmission channels as well as a network connection to another computer or networked device, and the Internet or Intranets including e-mail transmissions and information recorded on Websites and the like.

The computer programs (also called computer program code) are stored in main memory 408 and/or secondary memory 410. Computer programs can also be received via the communication interface 424. Such computer programs, when executed, enable the computing device 400 to perform one or more features of embodiments discussed herein. In various embodiments, the computer programs, when executed, enable the processor 404 to perform features of the above-described embodiments. Accordingly, such computer programs represent controllers of the computer system 400.

Software may be stored in a computer program product and loaded into the computing device 400 using the removable storage drive 414, the hard disk drive 412, or the interface 420. Alternatively, the computer program product may be downloaded to the computer system 400 over the communications path 426. The software, when executed by the processor 404, causes the computing device 400 to perform functions of embodiments described herein.

It is to be understood that the embodiment of FIG. 4 is presented merely by way of example. Therefore, in some embodiments one or more features of the computing device 400 may be omitted. Also, in some embodiments, one or more features of the computing device 400 may be combined together. Additionally, in some embodiments, one or more features of the computing device 400 may be split into one or more component parts.

It will be appreciated by a person skilled in the art that numerous variations and/or modifications may be made to the present disclosure as shown in the specific embodiments without departing from the spirit or scope of the disclosure as broadly described. The present embodiments are, therefore, to be considered in all respects to be illustrative and not restrictive.

We claim:

1. A processing device for facilitating a direct fund transfer from an aid organization to a service provider, comprising:
an account management module configured to:
maintain an aid organization account associated with the aid organization;
maintain a beneficiary account associated with each beneficiary that is enrolled with the aid organization, wherein each beneficiary account is configured as a virtual stored-value account for storing value corresponding to funds from the aid organization; and
maintain a service provider account associated with each service provider; and
a transaction settlement module configured to:
receive transaction data corresponding to a transaction between a beneficiary and a service provider, wherein the transaction data comprises a beneficiary identifier, a service provider identifier and a transaction amount, wherein the account management module is further configured to:
debit a value corresponding to the transaction amount from the beneficiary account that is mapped to the beneficiary identifier, and wherein the transaction settlement module is further configured to:
transfer funds corresponding to the transaction amount from the aid organization account directly to the service provider account that is mapped to the service provider identifier.

2. The device of claim 1, wherein the transaction settlement module is further configured to transfer the funds corresponding to the transaction amount from the aid organization account directly to the service provider account that is mapped to the service provider identifier at a pre-determined frequency level.

3. The device of claim 2, wherein the pre-determined frequency level is determined by the aid organization and the service provider.

4. The device of claim 1, wherein the processing device is in communication with a service provider device using a message format and a communication flow in accordance with ISO 8583, and wherein the service provider device is configured to generate the transaction data corresponding to the transaction between the beneficiary and the service provider.

5. The device of claim 4, wherein the account management module is further configured to:
receive, from an aid organization device, the beneficiary identifier and a value to be stored in the virtual stored-value account;
create the beneficiary account and map the beneficiary account to the beneficiary identifier; and
update the beneficiary account based on the value to be stored in the virtual stored-value account.

6. The device of claim 5, wherein the account management module is further configured to:
receive, from the aid organization device, the service provider identifier; and
create the service provider account and map the service provider account to the service provider identifier.

7. The device of claim 6, wherein the account management module is further configured to:
update the service provider account that is mapped to the service provider identifier by crediting the value corresponding to the transaction amount; and
update the aid organization account by debiting the value corresponding to the transaction amount.

8. A method for facilitating a direct fund transfer from an aid organization to a service provider, comprising:
maintaining, by an account management module, an aid organization account associated with the aid organization;
maintaining, by the account management module, a beneficiary account associated with each beneficiary that is enrolled with the aid organization;
configuring, by the account management module, each beneficiary account as a virtual stored-value account for storing value corresponding to funds from the aid organization;
maintaining, by the account management module, a service provider account associated with each service provider;
receiving, at a transaction settlement module that is in communication with the account management module, transaction data corresponding to a transaction between a beneficiary and a service provider, wherein the transaction data comprises a beneficiary identifier, a service provider identifier and a transaction amount;
debiting, by the account management module, a value corresponding to the transaction amount from the beneficiary account that is mapped to the beneficiary identifier; and
transferring, by the transaction settlement module, funds corresponding to the transaction amount from the aid organization account directly to the service provider account that is mapped to the service provider identifier.

9. The method of claim 8, further comprising transferring, by the transaction settlement module, the funds corresponding to the transaction amount from the aid organization account directly to the service provider account that is mapped to the service provider identifier at a pre-determined frequency level.

10. The method of claim 9, wherein the pre-determined frequency level is determined by the aid organization and the service provider.

11. The method of claim 8, further comprising generating, at a service provider device, the transaction data corresponding to the transaction between the beneficiary and the service provider, wherein the service provider device is in communication with the transaction settlement module using a message format and a communication flow in accordance with ISO 8583.

12. The method of claim 11, further comprising:
receiving, at the account management module from an aid organization device, the beneficiary identifier and a value to be stored in the virtual stored-value account;
creating, by the account management module, the beneficiary account;
mapping, by the account management module, the beneficiary account to the beneficiary identifier; and
updating, by the account management module, the beneficiary account based on the value to be stored in the virtual stored-value account.

13. The method of claim 12, further comprising:
receiving, at the account management module from the aid organization device, the service provider identifier;
creating, by the account management module, the service provider account; and
mapping, by the account management module, the service provider account to the service provider identifier.

14. The method of claim 13, further comprising:
updating, by the account management module, the service provider account that is mapped to the service provider identifier by crediting the value corresponding to the transaction amount; and
updating, by the account management module, the aid organization account by debiting the value corresponding to the transaction amount.

15. A system for facilitating a direct fund transfer from an aid organization to a service provider, comprising:
a processor;
memory communicatively coupled to the processor; and
logic communicatively coupled to the processor to:
maintain, via an account management module, an aid organization account associated with the aid organization;
maintain, by the account management module, a beneficiary account associated with each beneficiary that is enrolled with the aid organization;
configure, by the account management module, each beneficiary account as a virtual stored-value account for storing value corresponding to funds from the aid organization;
maintain, by the account management module, a service provider account associated with each service provider;
receive, at a transaction settlement module that is in communication with the account management module, transaction data corresponding to a transaction between a beneficiary and a service provider, wherein the transaction data comprises a beneficiary identifier, a service provider identifier and a transaction amount;
debit, by the account management module, a value corresponding to the transaction amount from the beneficiary account that is mapped to the beneficiary identifier; and
transfer, by the transaction settlement module, funds corresponding to the transaction amount from the aid organization account directly to the service provider account that is mapped to the service provider identifier.

16. The system of claim 15, wherein the logic is further to:
transfer, by the transaction settlement module, the funds corresponding to the transaction amount from the aid organization account directly to the service provider account that is mapped to the service provider identifier at a pre-determined frequency level.

17. The system of claim 16, wherein the pre-determined frequency level is determined by the aid organization and the service provider.

18. The system of claim 15, wherein the logic is further to:
generate, at a service provider device, the transaction data corresponding to the transaction between the beneficiary and the service provider, wherein the service provider device is in communication with the transaction settlement module using a message format and a communication flow in accordance with ISO 8583.

19. The system of claim 18, wherein the logic is further to:
receive, at the account management module from an aid organization device, the beneficiary identifier and a value to be stored in the virtual stored-value account;
create, by the account management module, the beneficiary account;
map, by the account management module, the beneficiary account to the beneficiary identifier; and
update, by the account management module, the beneficiary account based on the value to be stored in the virtual stored-value account.

20. The system of claim 19, wherein the logic is further to:
receive, at the account management module from the aid organization device, the service provider identifier;
create, by the account management module, the service provider account;
map, by the account management module, the service provider account to the service provider identifier;
update, by the account management module, the service provider account that is mapped to the service provider identifier by crediting the value corresponding to the transaction amount; and
update, by the account management module, the aid organization account by debiting the value corresponding to the transaction amount.
